(19) United States
(12) Patent Application Publication
(10) Pub. No.: US 2015/0288764 A1
(43) Pub. Date: Oct. 8, 2015

(54) METHOD AND APPARATUS FOR CONTROLLING SMART TERMINAL

(71) Applicant: Xiaomi Inc., Beijing (CN)

(72) Inventors: Pengfei ZHANG, Beijing (CN); Yongfeng XIA, Beijing (CN); Jialin FAN, Beijing (CN); Yong CHEN, Beijing (CN); Heng QU, Beijing (CN)

(73) Assignee: Xiaomi Inc.

(21) Appl. No.: 14/520,944

(22) Filed: Oct. 22, 2014

Related U.S. Application Data
(63) Continuation of application No. PCT/CN2014/084455, filed on Aug. 15, 2014.

(30) Foreign Application Priority Data
Apr. 8, 2014 (CN) 201410138935.6

(51) Int. Cl. H04L 29/08

(52) U.S. Cl. CPC H04L 67/125

(57) ABSTRACT

A method for controlling smart terminals includes identifying a surrounding one of the smart terminals currently near a local terminal, and when the surrounding smart terminal is located in a predetermined safe region, performing at least one of sending a parameter control instruction to the surrounding smart terminal, sending the parameter control instruction to a predetermined one of the smart terminals, or changing a parameter setting of the local terminal according to a predetermined parameter setting.

### CROSS-REFERENCE TO RELATED APPLICATIONS

This application is Continuation of International Application No. PCT/CN2014/084455, filed Aug. 15, 2014, which is based upon and claims priority to Chinese Patent Application No. 201410138935.6, filed Apr. 8, 2014, the entire contents of both of which are incorporated herein by reference.

### TECHNICAL FIELD

The disclosure relates to Smart Homes and, more particularly, to a method and apparatus for controlling a smart terminal.

### BACKGROUND

In Smart Home, a remote control device for smart terminals is a widely used product and may have many functions for controlling all electric appliances in the home. The remote control device may need to control all the smart terminals in the Smart Home and thus has a lot of keys, each of which corresponds to the controlling of a certain smart terminal under a certain scenario. Therefore, a backside of each key is usually connected to many circuits and a series of operations will be triggered when a key is pressed.

Since there are many keys on one remote control device, users need to clearly know the operations which can be triggered by respective keys on the remote control device. Such a complicated operation makes the remote control device inconvenient for a user to use and easy to misoperate. In addition, each scenario and each smart terminal respectively have corresponding keys, and thus it is complicated to add, modify, or delete a function of the remote control device.

### SUMMARY

In accordance with the disclosure, there is provided a method for controlling smart terminals. The method includes identifying a surrounding one of the smart terminals currently near a local terminal, and when the surrounding smart terminal is located in a predetermined safe region, performing at least one of sending a parameter control instruction to the surrounding smart terminal, sending the parameter control instruction to a predetermined one of the smart terminals, or changing a parameter setting of the local terminal according to a predetermined parameter setting.

Also in accordance with the disclosure, there is provided an apparatus for controlling smart terminals. The apparatus includes a processor, and a non-transitory computer-readable storage medium storing instructions that, when executed by the processor, cause the processor to identify a surrounding one of the smart terminals currently near a local terminal and when the surrounding smart terminal is located in a predetermined safe region, perform at least one of sending a parameter control instruction to the surrounding smart terminal, sending the parameter control instruction to a predetermined one of the smart terminals, or changing a parameter setting of the local terminal according to a predetermined parameter setting.

Also in accordance with the disclosure, there is provided a non-transitory computer-readable storage medium having stored therein instructions that, when executed by a processor of a local terminal, cause the processor to identify a surrounding smart terminal currently near the local terminal and when the surrounding smart terminal is located in a predetermined safe region, perform at least one of sending a parameter control instruction to the surrounding smart terminal, sending the parameter control instruction to a predetermined smart terminal, or changing a parameter setting of the local terminal according to a predetermined parameter setting.

Features and advantages consistent with the disclosure will be set forth in part in the description which follows, and in part will be obvious from the description, or may be learned by practice of the disclosure. Such features and advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flow chart showing a method for controlling a smart terminal according to an exemplary embodiment.

FIG. 2 is a flow chart showing identifying a smart terminal currently near a local terminal according to an exemplary embodiment.

FIG. 3 is a block diagram showing positions of smart terminals according to another exemplary embodiment.

FIG. 4 is a flow chart showing identifying a smart terminal currently near a local terminal according to another exemplary embodiment.

FIG. 5 is a flow chart showing a method for controlling a smart terminal according to another exemplary embodiment.

FIG. 6 is a flow chart showing a method for controlling a smart terminal according to another exemplary embodiment.

FIG. 7 is a flow chart showing a method for controlling a smart terminal according to another exemplary embodiment.

FIG. 8 is a flow chart showing a method for controlling a smart terminal according to another exemplary embodiment.

FIG. 9 is block diagram showing an apparatus for controlling a smart terminal according to an exemplary embodiment.

FIG. 10 is a block diagram showing an identifying module according to an exemplary embodiment.

FIG. 11 is a block diagram showing an instruction sending module according to an exemplary embodiment.

FIG. 12 is a block diagram showing an identifying module according to an exemplary embodiment.

FIG. 13 is a block diagram showing an apparatus for controlling a smart device according to an exemplary embodiment.

FIG. 14 is a block diagram showing a router according to an exemplary embodiment.

### DETAILED DESCRIPTION

Embodiments consistent with the disclosure include a method and apparatus for controlling a smart terminal.

Hereinafter, embodiments consistent with the disclosure will be described with reference to the drawings. Wherever possible, the same reference numbers will be used throughout the drawings to refer to the same or like parts.

Respective embodiments in the disclosure can be applied in various smart terminals, for example, a device close to human body such as a wristwatch or a bracelet, a mobile terminal such as a mobile phone or a tablet computer, a router, or a smart electric appliance such as a smart television or a smart refrigerator. In some embodiments, the device close to human body can detect and control other smart terminals through an infrared radiation. In some embodiments, the mobile terminal or the router can detect or control other smart terminals through a network such as a WiFi network.

FIG. 1 is a flow chart showing an exemplary method for controlling a smart terminal consistent with embodiments of the disclosure. As shown in FIG. 1, at S11, a smart terminal currently near a local terminal is identified. Such a smart terminal is also referred to as a surrounding smart terminal.

At S12, when the smart terminal is located in a predetermined safe region, a parameter control instruction is sent to the smart terminal or a predetermined smart terminal according to a predetermined parameter setting, or an own parameter setting of the local terminal is changed according to a predetermined parameter setting.

For example, if the local terminal is a router, when a mobile phone is connected to the router, the router determines that the mobile phone is located in a predetermined safe region, and the router can perform predetermined operations, sending a parameter control instruction to a predetermined smart terminal, for example, an instruction to turn on a light, an instruction to turn on an air conditioner, or an instruction to close curtains. The router can also send a parameter control instruction to the mobile phone to, for example, unlock the mobile phone. The router can also judge whether a mobile phone reaches a predetermined safe region according to location information continuously reported by the mobile phone.

As another example, if the local terminal is a mobile phone, the mobile phone detects a router in a home. The home is a relatively private region and thus can be determined as a predetermined safe region. Thus, the mobile phone determines that it is located in the predetermined safe region and changes its own parameter setting according to the predetermined parameter setting, for example, hidden information in the mobile phone is changed into displayed information.

Another example of the local terminal is a wearable device (such as a bracelet) worn by a user. The wearable device can detect a smart terminal such as a smart electric appliance, and control operations of that smart terminal (such as starting of the smart terminal). For example, when a user wearing a bracelet approaches a television, the bracelet detects the television and then sends a starting instruction to the television. When a plurality of smart terminals is detected, starting of the plurality of smart terminals can be controlled. Alternatively, which one of the plurality of smart terminals is to receive the starting instruction can be determined according to the distance between each smart terminal and the bracelet. As another example, if the local terminal is a device close to human body (hereinafter, also referred to as a “near-body device”) such as a wristwatch, the device can send the parameter control instruction to a mobile phone for unlocking the screen of the phone when detecting that the distance from the mobile phone to the terminal is within a safe range. Similarly, if the local terminal is a mobile phone, the mobile phone can change its own parameter setting when detecting that the distance from a predetermined device (such as a smart bracelet) to the local terminal is within a safe range.

As described above, the smart terminal is automatically controlled according to the preset control rules by obtaining the position of the smart terminal. Thus, a user can more easily and accurately control the smart terminal in the Smart Home, and thus can have a better experience of the Smart Home.

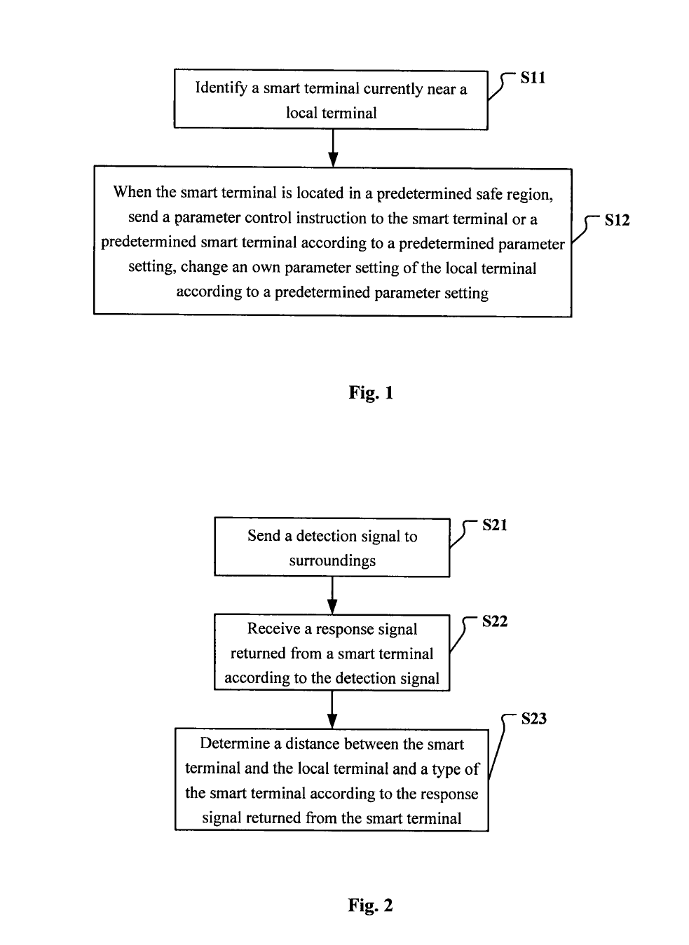

FIG. 2 is a flow chart showing an exemplary method for identifying a smart terminal currently near a local terminal, i.e., S11 in FIG. 1, consistent with embodiments of the disclosure. As shown in FIG. 2, identifying a smart terminal currently near a local terminal includes the following.

At S21, a detection signal is sent to the surroundings of the local terminal.

At S22, a response signal returned from a smart terminal according to the detection signal is received.

At S23, a distance between the smart terminal and the local terminal and a type of the smart terminal are determined according to the response signal returned from the smart terminal.

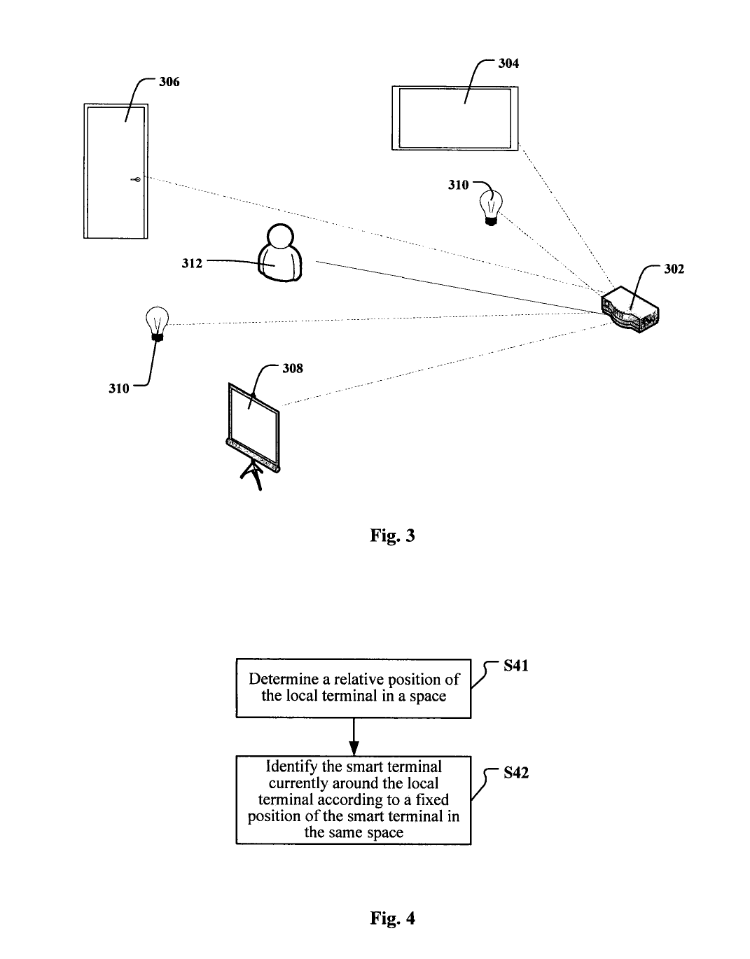

For example, as shown in FIG. 3, the local terminal may be a router 302. The router 302 can send a detection signal to a smart terminal (such as a smart curtain 304, a smart door 306, a smart television 308, or a smart light 310) at home in a radiation manner. After receiving the detection signal, the smart terminal may return a response signal to the router 302. According to the received response signal, the router 302 can determine the distance between the smart terminal and the router 302, and can determine the type of the smart terminal. For example, the router 302 can determine the type of the smart terminal by determining a port number or some port numbers of the smart terminal.

Similarly, when the local terminal is a device close to a user, such as a wristwatch or a bracelet, or a mobile terminal, such a local terminal can determine the smart terminal currently near the local terminal in a manner similar to that described above.

In some embodiments, if the local terminal is a router or a mobile terminal, S12 in FIG. 1 includes obtaining a predetermined operation corresponding to a smart terminal when the smart terminal is located in a predetermined safe region, and sending the parameter control instruction to the smart terminal corresponding to the predetermined operation.

Generally, a mobile terminal such as a mobile phone, or a near-body device such as a wristwatch, is carried by a user, and therefore a position of the mobile terminal or the near-body device can be considered to be a position of the user.

For example, when the router detects that a mobile phone is located at a position in a home, for example in a living room, the router obtains a predetermined operation corresponding to the mobile phone. That is, when the router detects that a user with the mobile phone is in the living room, the router determines which smart electric appliances need to be controlled to perform operations under such scenario. For example, the router sends a parameter control instruction to a smart television to control the smart television to turn on. In some embodiments, the predetermined operation may correspond to two or more predetermined smart terminals.

In some embodiments, it can be preset that when a certain smart terminal is located in a certain position, predetermined operations for controlling that certain smart terminal itself are performed, or predetermined operations for controlling other smart terminals are performed according to the position of that certain smart terminal. Thus, the control for the smart terminals in the home becomes more convenient and faster, and can meet users' actual requirements. Therefore, the users can have better experience on the Smart Home without too many operations.

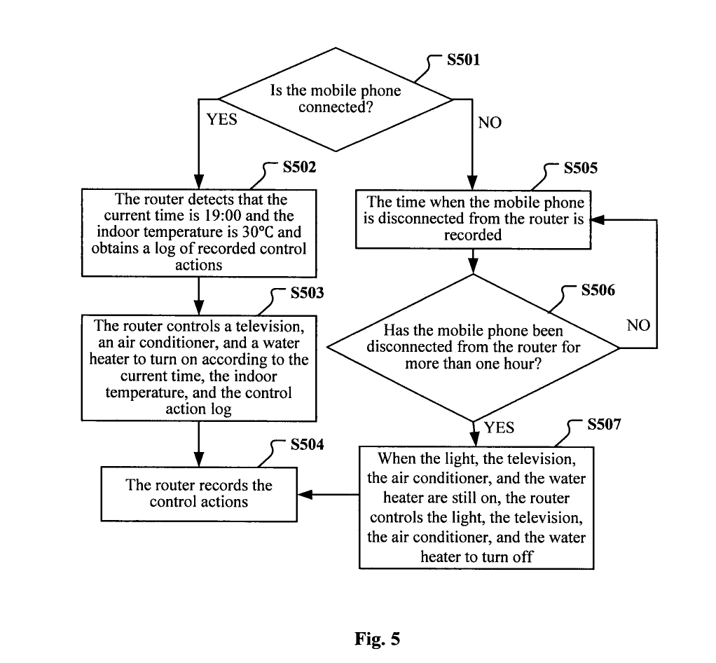

FIG. 4 is a flow chart showing an exemplary method for identifying a smart terminal currently near a local terminal, i.e., S11 in FIG. 1, consistent with embodiments of the disclosure. As shown in FIG. 4, when the local terminal is an unfixed device such as a near-body device and a mobile terminal, identifying a smart terminal currently near the local terminal includes the following.

At S41, a relative position of the local terminal in a space is determined.

At S42, a smart terminal currently near the local terminal is identified according to a fixed position of the smart terminal in a same space.

For example, with reference to FIG. 3, assume a user 312 wearing a wristwatch walks into a room, the wristwatch detects its own relative position in the space. For a device having a fixed position such as the router 302 or the smart electric appliances, the wristwatch identifies the smart terminal currently near the wristwatch according to the detected fixed positions of the router 302 and the smart electric appliances. In some embodiments, the router 302 can also identify the smart terminal currently near it by a similar manner. The router 302 and the smart electric appliances have relatively fixed positions, and thus the relative position or the fixed position may only need to be determined once.

In some embodiments, the near-body device or the mobile terminal detects its own position and positions of other smart terminals so as to determine the smart terminal currently near the near-body device or the mobile terminal—the local terminal in this scenario. Thus, position detection and determination of the surrounding smart terminals become more convenient and faster.

In some embodiments, for a local terminal including an unfixed device, such as a near-body device or a mobile terminal, detecting a relative position of the local terminal in a space, i.e., S41 in FIG. 4, includes sending a locating signal to a routing device providing network resources for the local terminal and all smart terminals, and receiving a relative position of the local terminal in the space returned from the routing device. The relative position includes a relative position with respect to the routing device and/or a relative position with respect to one or more of the smart terminals.

For example, a wristwatch sends a locating signal to a router in a home. After receiving the locating signal, the router determines the relative position of the wristwatch in the home in the manner as shown in FIG. 2, and returns the relative position to the wristwatch. Thus, the wristwatch can obtain its own relative position in the home.

In some embodiments, the position of the near-body device or the mobile terminal can also be detected by the router, which is more convenient and accurate. Furthermore, the functions of the near-body device are reduced and thus the size of the near-body device can be decreased. Consequently, the near-body device is easier to carry, the user's operations are less, and the cost of the near-body device is lowered.

In some embodiments, for a local terminal including an unfixed device, such as a near-body device or a mobile terminal, if the relative position of the local terminal in the space is a position relative to the routing device, S42 in FIG. 4, i.e., identifying the smart terminal currently near the local terminal according to a fixed position of the smart terminal in the same space, includes identifying the smart terminal currently near the local terminal according to fixed positions of the smart terminal and the routing device in the space. Alternatively, if the relative position of the local terminal in the space is a relative position with respect to the smart terminal, S42 includes identifying the smart terminal currently near the local terminal according to a distance between each smart terminal and the local terminal.

For example, the wristwatch can determine a smart electric appliance currently near the wristwatch according to a relative position of the wristwatch itself with respect to the router and fixed positions of smart electric appliances and the router. Alternatively, the wristwatch can identify the smart electric appliance currently near the wristwatch according to a relative position of the wristwatch itself with respect to the smart electric appliances and a distance between the wristwatch and each electric appliance.

Since the positions of the smart electric appliances and the router in a home are generally fixed, for a local terminal that is an unfixed device, such as a near-body device or a mobile terminal, the smart terminal currently near the local terminal can be identified according to the relative position with respect to the router or the relative positions with respect to other smart electric appliances. Thus, the determination of surrounding smart terminals becomes faster.

In some embodiments, devices near other smart terminals can be identified by the router. In such a scenario, S42 in FIG. 4, i.e., identifying the smart terminal currently near the local terminal according to a fixed position of the smart terminal in the same space, includes sending a locating signal to the routing device and then receiving a confirmation response returned from the routing device. The confirmation response includes information regarding the smart terminal currently near the local terminal.

For example, a wristwatch sends a locating signal to a router. After receiving the locating signal, the router identifies the smart electric appliances currently near the wristwatch according to the relative position of the wristwatch in the home and the fixed positions of the other smart electric appliances in the home or the relative positions of the other smart electric appliances with respect to the router, and sends a confirmation response including information regarding the smart electric appliances currently near the wristwatch to the wristwatch.

Since the router can obtain positions of all the smart terminals in a home, determination of the smart terminal currently near any smart terminal in the home can be performed by the router, which is more accurate. Furthermore, the functions of the near-body device (such as the wristwatch) are reduced and thus the size of the near-body device can be decreased. Consequently, the near-body device becomes easier to carry, user's operations are less, and cost of the near-body device is lowered.

Usually there are a large number of indoor smart terminals in a home. For example, a living room may have a light, an air conditioner, a television, a speaker, curtains, and so on. A bedroom may have a light, an air conditioner, a television, curtains, and so on. Therefore, if only positions of the smart terminals are used to determine which smart terminals to operate, it may not meet the user's actual need. For example, when a mobile phone is detected to be in a bedroom at 23:00, it may be possible that the user does not want to turn on the light or the television. As another example, when the temperature of the living room is 30° C., the user may wish to turn on the air conditioner, rather than the television or the speaker. Thus, when controlling the smart terminals, factors such as time and environment shall also be considered.

In some embodiments, S12 in FIG. 1 further includes, when the smart terminal is located in the predetermined safe region, sending the parameter control instruction to the smart terminal or the predetermined smart terminal according to current time and/or environment information. Alternatively, S12 may include, when the smart terminal is located in the predetermined safe region, changing the parameter setting of the local terminal according to the current time and/or environment information.

The environment information may include indoor temperature, humidity, brightness, noise value, and so on.

For example, when the mobile phone is detected to be in the living room, if the current time is 20:00, the near-body device or the router can send an instruction to the light in the living room to turn on the light. When it is detected that the temperature of the living room is 30° C., the near-body device or the router can send an instruction to the air conditioner in the living room to turn on the air conditioner. Further, when the mobile phone is detected to be in the living room, if the current time is 8:30 and the temperature in the living room is 28° C., the air conditioner in the living room is not turned on since the user may need to leave home for work. When the mobile phone is detected to be in the bedroom, if the current time is 23:00 and the temperature in the bedroom is 30° C., the light in the bedroom is turned off and the air conditioner in the bedroom is turned on. Alternatively or additionally, when the mobile phone is detected to be in the bedroom, if the current time is 23:00, the mobile phone can automatically set itself to a mute mode.

According to the current time and/or environment information, different settings can be applied in different scenarios, and detailed descriptions thereof are omitted.

Thus, not only the position of the smart terminal but also current time and/or environment information is considered, and thus the control on the smart terminals in a home can be more accurate and better meet the user's actual needs, further improving the user's experience with the Smart Home.

In some embodiments, the method for controlling smart terminals further includes recording a control action of sending the parameter control instruction to the smart terminal or the predetermined smart terminal or a control action of changing the parameter setting of the local terminal according to the predetermined parameter setting, and sending the parameter control instruction to the smart terminal or the predetermined smart terminal according to the recorded control action or changing the parameter setting of the local terminal according to the recorded control action.

For example, it is recorded that the television and the light are usually turned on when the mobile terminal is detected to be in the living room at 20:00. Thus, when it is detected again that the mobile phone is in the living room at 20:00, the parameter control instruction is sent to the television and the light. As another example, it is recorded that the mobile phone is usually set to a mute mode when the mobile phone is detected to be in the bedroom at 23:00. Thus, when it is detected again that the mobile phone is in the bedroom at 23:00, the parameter settings of the mobile phone are changed.

The recorded control actions can at least include the controlled smart terminal and controlling time in each control.

Various control actions can be learned so as to be used as a basis for next control on the smart terminals. Thus, the control on the smart terminals can better comply with the user's habits and better meet the user's actual needs, further improving the user's experience on the Smart Home.

Several actual application scenarios of the embodiments of the disclosure will be described below in detail.

FIG. 5 is a flow chart showing an exemplary method for controlling a smart terminal consistent with embodiments of the disclosure. As shown in FIG. 5, a router controls smart electric appliances to perform predetermined operations by determining whether a mobile phone is connected to or disconnected from the router.

At S501, the router detects whether the mobile phone is connected. If so, S502 is performed. Otherwise, S505 is performed.

At S502, the router detects that the current time is 19:00 and the indoor temperature is 30° C., and obtains a log of recorded control actions.

At S503, the router controls a television, an air conditioner, and a water heater to turn on according to the current time, the indoor temperature, and the control action log.

At S504, the router records the control actions and the flow chart ends.

At S505, the time when the mobile phone is disconnected from the router is recorded.

At S506, it is judged whether the mobile phone has been disconnected from the router for more than one hour. If so, S507 is performed. Otherwise, S505 is performed.

At S507, when the light, the television, the air conditioner, and the water heater are still on, the router controls the light, the television, the air conditioner, and the water heater to turn off, and then S504 is performed.

The router judges whether a user arrives at home or leaves home by judging whether the mobile phone is connected to or disconnected from the router, and then sends parameter control instructions to the smart electric appliances in the home according to predetermined parameter settings so as to control the smart electric appliances to perform predetermined operations.

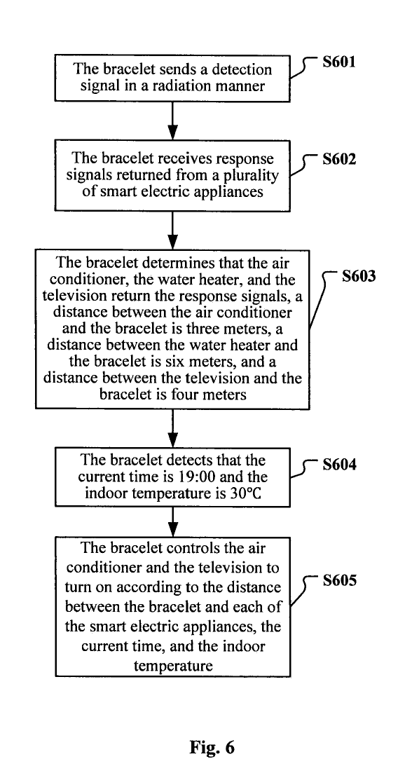

FIG. 6 is a flow chart showing another exemplary method for controlling a smart terminal consistent with embodiments of the disclosure. As shown in FIG. 6, a near-body device, such as a bracelet or a wristwatch, controls surrounding smart electric appliances to perform predetermined operations according to predetermined parameter settings.

At S601, the bracelet sends a detection signal in a radiation manner.

At S602, the bracelet receives response signals returned from a plurality of smart electric appliances.

At S603, the bracelet determines that the air conditioner, the water heater, and the television returned the response signals, a distance between the air conditioner and the bracelet is three meters, the distance between the water heater and the bracelet is six meters, and the distance between the television and the bracelet is four meters.

At S604, the bracelet detects that the current time is 19:00 and the indoor temperature is 30° C.

At S605, the bracelet controls the air conditioner and the television to turn on according to the distance between the bracelet and each of the smart electric appliances, the current time, and the indoor temperature.

In some embodiments, the bracelet can control which smart electric appliance to turn on according to at least one of the distance between the bracelet and each of the smart electric appliances, the current time, and the indoor temperature. Additionally, other factors can be used as the basis for controlling which smart electric appliance to turn on.

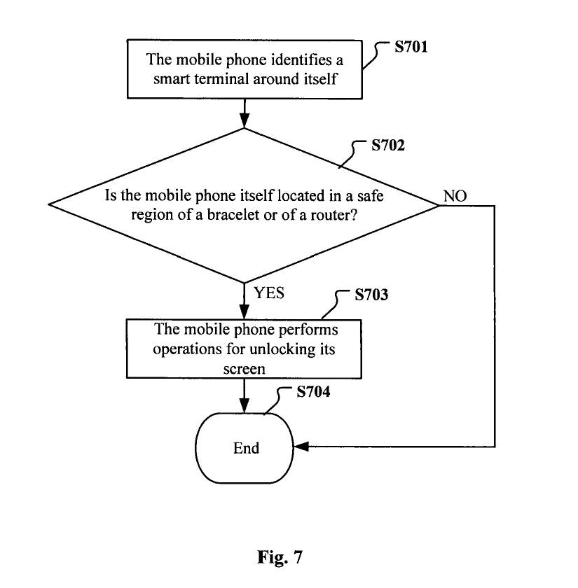

FIG. 7 is a flow chart showing another exemplary method for controlling a smart terminal consistent with embodiments of the disclosure. As shown in FIG. 7, when a mobile phone detects that the mobile phone itself is located in a safe region of a near-body device, such as a bracelet or a wristwatch, or a router, the mobile phone changes its own parameter settings to perform predetermined operations.

At S701, the mobile phone identifies a smart terminal near itself

At S702, the mobile phone judges whether it is located in a safe region of a bracelet or a router. If so, S703 is performed. Otherwise, S704 is performed.

At S703, the mobile phone performs operations for unlocking its screen.

At S704, the process ends.

When the mobile bracelet is located in a safe region of the bracelet, i.e., when the user carrying the bracelet contacts the mobile phone, the mobile phone can automatically perform operations for unlocking its screen for the user to use the mobile phone. In addition, when the mobile phone is located in a safe region of the router, which means that the user carrying the mobile phone may have arrived at home, the mobile phone can change other settings of its own in addition to unlocking the screen, such as, for example, lifting the requirement for password for certain small-amount payments, or displaying certain hidden personal information in the mobile phone, such as work plan or contact information.

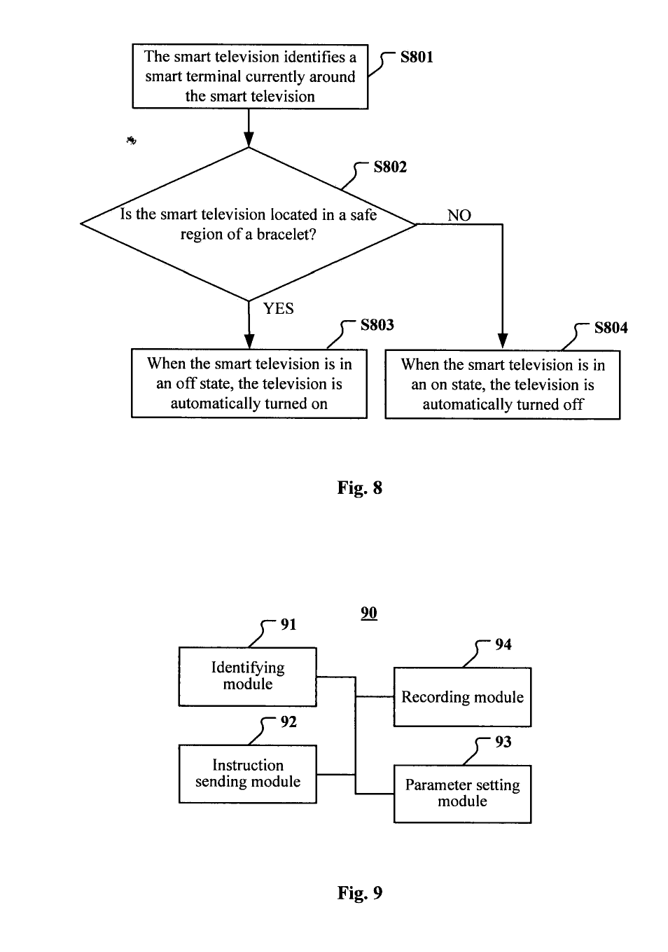

FIG. 8 is a flow chart of another exemplary method for controlling a smart terminal consistent with embodiments of the disclosure. As shown in FIG. 8, when a smart television detects that it is located in a safe region of a near-body device, such as a bracelet, the smart television changes its own parameter settings.

At S801, the smart television identifies a smart terminal currently near the smart television, which is the local terminal in this example.

At S802, the smart television judges whether the smart television itself is located in a safe region of a bracelet. If so, S803 is performed. Otherwise, S804 is performed.

At S803, when the smart television is in an off state, the television is automatically turned on, and the process ends.

At S804, when the smart television is in an on state, the television is automatically turned off, and the process ends.

The near-body device is usually carried by a user, and thus a smart electric appliance, such as a smart television, can judge whether the user is nearby according to its position relative to the near-body device, so as to perform operations of automatically turning on or off.

The application scenarios of the method for controlling a smart terminal of the disclosure are not limited to the above scenarios. Considering various scenarios, respective smart terminals in a Smart Home can be configured, so as to more accurately control the smart terminals in the Smart Home, and to better meet the user's actual needs. As such, the user's experience in the Smart Home is further improved.

FIG. 9 is a block diagram showing an exemplary apparatus 90 for controlling a smart terminal consistent with embodiments of the disclosure. As shown in FIG. 9, the apparatus 90 includes an identifying module 91, an instruction sending module 92, a parameter setting module 93, and a recording module 94. It is noted that FIG. 9 is for illustration purpose. An apparatus consistent with embodiments of the disclosure does not need to have each and every module shown in FIG. 9. For example, an apparatus consistent with embodiments of the disclosure may just include the identifying module 91 and the instruction sending module 92 or just include the identifying module 91 and the parameter setting module 93.

Consistent with embodiments of the disclosure, the identifying module 91 is configured to identify a smart terminal currently near a local terminal. The instruction sending module 92 is configured to send a parameter control instruction to the smart terminal or a predetermined smart terminal according to a predetermined parameter setting, when the smart terminal is located in a predetermined safe region. The parameter setting module 93 is configured to change the parameter setting of the local terminal according to a predetermined parameter setting, when the smart terminal is located in a predetermined safe region.

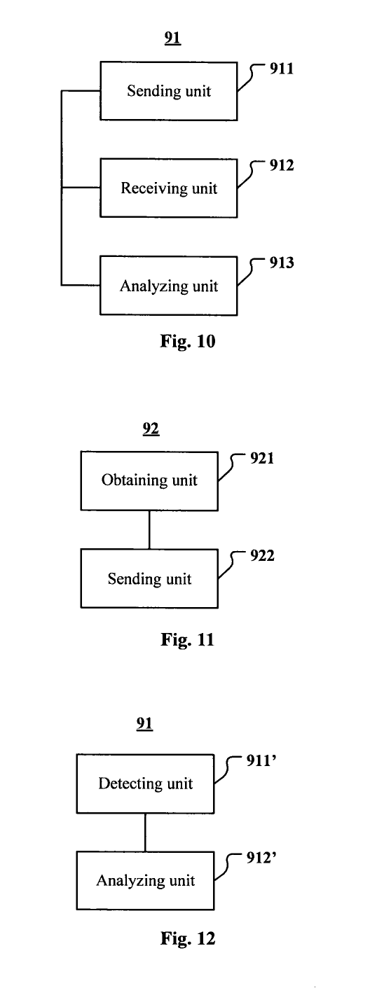

FIG. 10 is a block diagram showing an example of the identifying module 91 consistent with embodiments of the disclosure. As shown in FIG. 10, the identifying module 91 includes a sending unit 911, a receiving unit 912, and an analyzing unit 913. The sending unit 911 is configured to send a detection signal to surroundings. The receiving unit 912 is configured to receive a response signal returned from a smart terminal according to the detection signal. The analyzing unit 913 is configured to determine a distance between the smart terminal and the local terminal, and a type of the smart terminal, according to the response signal returned from the smart terminal.

FIG. 11 is a block diagram showing an example of the instruction sending module 92 consistent with embodiments of the disclosure. As shown in FIG. 11, the instruction sending module 92 includes an obtaining unit 921 and a sending unit 922. The obtaining unit 921 is configured to obtain a predetermined operation corresponding to the smart terminal, when the smart terminal is located in the predetermined safe region. The sending unit 922 is configured to send the parameter control instruction to the predetermined smart terminal corresponding to the predetermined operation.

FIG. 12 is a block diagram showing another example of the identifying module 91 consistent with embodiments of the disclosure. As shown in FIG. 12, the identifying module 91 includes a detecting unit 911′ and an analyzing unit 912′. The detecting unit 911′ is configured to detect a relative position of the local terminal in a space. The analyzing unit 912′ is configured to identify the smart terminal currently near the local terminal according to a fixed position of the smart terminal in the same space.

In some embodiments, the detecting unit 911′ is configured to send a locating signal to a routing device that provides network resources for the local terminal and all smart terminals, and receive the relative position of the local terminal in the space returned from the routing device. The relative position includes a relative position with respect to the routing device and/or a relative position with respect to one or more of the smart terminals.

In some embodiments, the analyzing unit 912′ is configured to identify the smart terminal currently near the local terminal according to fixed positions of the smart terminal and the routing device in the space, when the relative position of the local terminal in the space is a relative position with respect to the routing device. The analyzing unit 912′ is further configured to identify the smart terminal currently near the local terminal according to a distance between each of the smart terminals and the local terminal, when the relative position of the local terminal in the space is a relative position with respect to each of the smart terminals.

In some embodiments, the analyzing unit 912′ is configured to receive a confirmation response returned from the routing device, after a locating signal is sent to the routing device. The confirmation response includes information regarding the smart terminal currently near the local terminal.

In some embodiments, the instruction sending module 92 is configured to send the parameter control instruction to the smart terminal or the predetermined smart terminal according to current time and/or environment information, when the smart terminal is located in the predetermined safe region.

The parameter setting module 93 is configured to change the parameter setting of the local terminal according to the current time and/or environment information, when the smart terminal is located in the predetermined safe region.

Consistent with embodiments of the disclosure, the recording module 94 is configured to record a control action of sending the parameter control instruction to the smart terminal or the predetermined smart terminal, or to record a control action of changing the parameter setting of the local terminal according to the predetermined parameter setting.

When the apparatus 90 includes the recording module 94, the instruction sending module 92 is further configured to send the parameter control instruction to the smart terminal or the predetermined smart terminal according to the recorded control action, and the parameter setting module 93 is further configured to change the parameter setting of the local terminal according to the recorded control action.

For the apparatus 90 described above, specific operations performed by respect modules have been described in detail with regard to the related method, and detailed description thereof is omitted here.

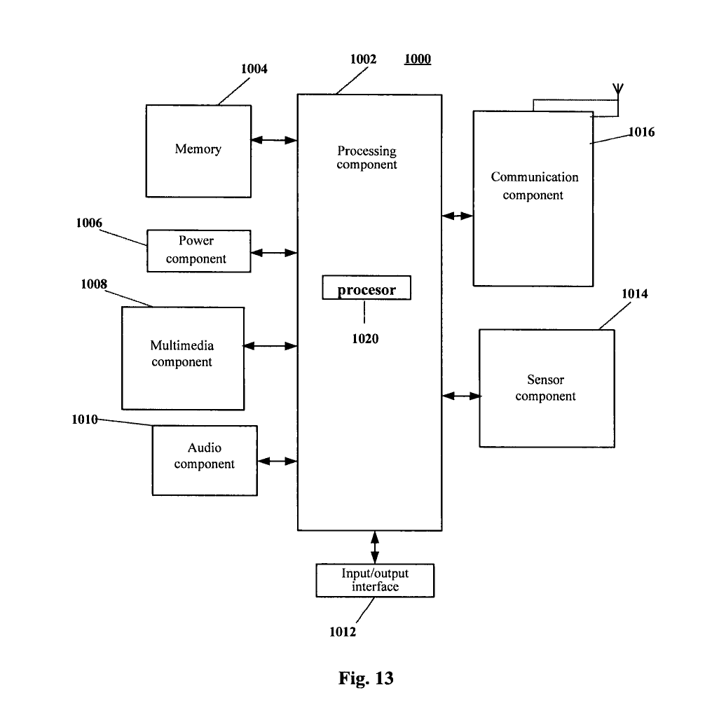

FIG. 13 is a block diagram of an apparatus 1000 for controlling a smart terminal consistent with embodiments of the disclosure. For example, the apparatus 1000 can be a mobile phone, a computer, a digital broadcast terminal, a messaging device, a gaming console, a tablet, a medical device, exercise equipment, a personal digital assistant, and the like.

Referring to FIG. 13, the apparatus 1000 includes one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the apparatus 1000, such as the operations associated with display, telephone calls, data communications, camera operations, and recording operations. The processing component 1002 includes one or more processors 1020 to execute instructions to perform all or part of the methods consistent with embodiments of the disclosure. Moreover, the processing component 1002 may include one or more modules which facilitate the interaction between the processing component 1002 and other components. For instance, the processing component 1002 can include a multimedia module to facilitate the interaction between the multimedia component 1008 and the processing component 1002.

The memory 1004 is configured to store various types of data to support the operation of the apparatus 1000. Examples of such data include instructions for any applications or methods operated on the apparatus 1000, contact data, phonebook data, messages, pictures, video, etc. The memory 1004 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the apparatus 1000. The power component 1006 can include a power management system, one or more power sources, and any other components associated with the generation, management, and distribution of power in the apparatus 1000.

The multimedia component 1008 includes a screen providing an output interface between the apparatus 1000 and the user. In some embodiments, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors can not only sense a boundary of a touch or swipe action, but also sense a period of time and a pressure associated with the touch or swipe action. In some embodiments, the multimedia component 1008 includes a front camera and/or a rear camera. The front camera and the rear camera can receive an external multimedia datum while the apparatus 1000 is in an operation mode, such as a photographing mode or a video mode. Each of the front camera and the rear camera can be a fixed optical lens system or have focus and optical zoom capability.

The audio component 1010 is configured to output and/or input audio signals. For example, the audio component 1010 includes a microphone (“MIC”) configured to receive an external audio signal when the apparatus 1000 is in an operation mode, such as a call mode, a recording mode, and a voice recognition mode. The received audio signal can be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons can include, but are not limited to, a home button, a volume button, a starting button, and a locking button.

The sensor component 1014 includes one or more sensors to provide status assessments of various aspects of the apparatus 1000. For instance, the sensor component 1014 can detect an open/closed status of the apparatus 1000, relative positioning of components, e.g., the display and the keypad, of the apparatus 1000, a change in position of the apparatus 1000 or a component of the apparatus 1000, a presence or absence of user contact with the apparatus 1000, an orientation or an acceleration/deceleration of the apparatus 1000, and a change in temperature of the apparatus 1000. The sensor component 1014 can include a proximity sensor configured to detect the presence of nearby objects without any physical contact. The sensor component 1014 can also include a light sensor, such as a CMOS or CCD image sensor, for use in imaging applications. In some embodiments, the sensor component 1014 can also include an accelerometer sensor, a gyroscope sensor, a magnetic sensor, a pressure sensor, or a temperature sensor.

The communication component 1016 is configured to facilitate communication, wired or wirelessly, between the apparatus 1000 and other devices. The apparatus 1000 can access a wireless network based on a communication standard, such as WiFi, 2G, or 3G or a combination thereof. In one exemplary embodiment, the communication component 1016 receives a broadcast signal or broadcast associated information from an external broadcast management system via a broadcast channel. In one exemplary embodiment, the communication component 1016 further includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1000 can be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium storing instructions that, when executed by a processor, cause the processor to perform a method for controlling a smart terminal consistent with embodiments of the disclosure. For example, the storage medium may be the memory 1004, which stores instruction executable by the processor 1020 in the apparatus 1000, for performing the above-described methods. The non-transitory computer-readable storage medium may be a ROM, a RAM, a CD-ROM, a magnetic tape, a floppy disc, an optical data storage device, and the like.

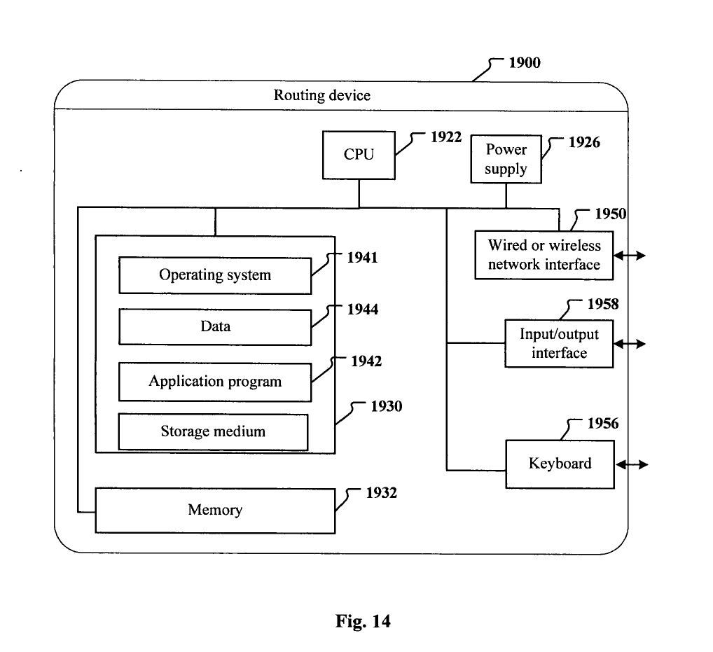

FIG. 14 is a block diagram showing a structure of an exemplary router 1900 consistent with embodiments of the disclosure. The structure of the router 1900 may be different for different configurations or performances, and includes one or more Central Processing Units (CPUs) 1922 (for example, one or more processors), a memory 1932, and one or more storage mediums 1930 (for example, one or more mass storage devices) for storing application program 1942 or data 1944. The memory 1932 and the storage medium 1930 can perform temporary storage or permanent storage. The program stored in the storage medium 1930 may include instructions controlling operations of the router 1900. Further, the CPU 1922 is configured to communicate with the storage medium 1930, and to perform the instructions stored in the storage medium 1930.

The router 1900 further includes one or more power supplies 1926, one or more wired or wireless network interfaces 1950, one or more input/output interfaces 1958, one or more keyboards 1956 and/or one or more operating systems 1941, such as Windows Server™, Mac OS X™, Unix™, Linux™, FreeBSD™, and the like.

Those skilled in the art will recognize that part or all of the methods described above may be implemented with hardware, or programs instructing the related hardware. The programs may be stored in a computer readable storage medium. The storage medium described above may be a read-only memory, a magnetic disc, an optical disc or the like.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for controlling smart terminals, comprising:
identifying, by at least one processor, a surrounding one of the smart terminals currently near a local terminal; and
performing at least one of the following when the surrounding smart terminal is located in a predetermined safe region:
sending, by the at least one processor, a parameter control instruction to the surrounding smart terminal;
sending, by the at least one processor, the parameter control instruction to a predetermined one of the smart terminals; or
changing, by the at least one processor, a parameter setting of the local terminal according to a predetermined parameter setting.

2. The method according to claim 1, wherein identifying the surrounding smart terminal currently near a local terminal includes:
sending a detection signal to surroundings;
receiving a response signal returned from the surrounding smart terminal according to the detection signal; and
determining a distance between the surrounding smart terminal and the local terminal, and a type of the surrounding smart terminal, according to the response signal.

3. The method according to claim 1, wherein sending the parameter control instruction to the predetermined smart terminal includes:
obtaining a predetermined operation corresponding to the surrounding smart terminal when the surrounding smart terminal is located in the predetermined safe region; and
sending the parameter control instruction to the predetermined smart terminal corresponding to the predetermined operation.

4. The method according to claim 1, wherein identifying the surrounding smart terminal currently near the local terminal includes:
identifying the surrounding smart terminal currently near the local terminal according to a fixed position of the surrounding smart terminal in a space.

5. The method according to claim 4, wherein identifying the surrounding smart terminal currently near the local terminal further includes:
detecting a relative position of the local terminal in the space, including:
sending a locating signal to a routing device providing network resources for the local terminal and the surrounding smart terminal; and
receiving the relative position of the local terminal in the space returned from the routing device,
wherein the relative position includes at least one of a first relative position with respect to the routing device or a second relative position with respect to the surrounding smart terminal.

6. The method according to claim 5, wherein identifying the surrounding smart terminal currently near the local terminal according to the fixed position of the surrounding smart terminal in the space includes:
identifying the surrounding smart terminal currently near the local terminal according to the fixed position of the surrounding smart terminal and a fixed position of the routing device in the space, if the relative position of the local terminal includes the first relative position; or
identifying the surrounding smart terminal currently near the local terminal according to a distance between the surrounding smart terminal and the local terminal, if the relative position of the local terminal includes the second relative position.

7. The method according to claim 5, wherein identifying the surrounding smart terminal currently near the local terminal according to the fixed position of the surrounding smart terminal in the space includes:
receiving a confirmation response returned from the routing device after sending the locating signal to the routing device, the confirmation response including information regarding the surrounding smart terminal.

8. The method according to claim 1, wherein:
sending the parameter control instruction to the surrounding smart terminal includes sending the parameter control instruction to the surrounding smart terminal according to at least one of a current time or environment information,
sending the parameter control instruction to the predetermined smart terminal includes sending the parameter control instruction to the predetermined smart terminal according to at least one of the current time or the environment information, and
changing the parameter setting of the local terminal includes changing the parameter setting of the local terminal according to at least one of the current time or the environment information.

9. The method according to claim 1, further comprising:
recording a control action including at least one of sending the parameter control instruction to the surrounding smart terminal, sending the parameter control instruction to the predetermined smart terminal, or changing the parameter setting of the local terminal according to the predetermined parameter setting; and
performing at least one of the following according to the recorded control action:
sending the parameter control instruction to the surrounding smart terminal;
sending the parameter control instruction to the predetermined smart terminal; or
changing the parameter setting of the local terminal.

10. An apparatus for controlling smart terminals, comprising:
a processor; and
a non-transitory computer-readable storage medium storing instructions that, when executed by the processor, cause the processor to:
identify a surrounding one of the smart terminals currently near a local terminal; and
perform at least one of the following when the surrounding smart terminal is located in a predetermined safe region:
sending a parameter control instruction to the surrounding smart terminal;
sending the parameter control instruction to a predetermined one of the smart terminals; or
changing a parameter setting of the local terminal according to a predetermined parameter setting.

11. The apparatus according to claim 10, wherein the instructions causing the processor to identify the surrounding smart terminal currently near the local terminal includes instructions causing the processor to:
send a detection signal to surroundings;
receive a response signal returned from the surrounding smart terminal according to the detection signal; and
determine a distance between the surrounding smart terminal and the local terminal, and a type of the surrounding smart terminal, according to the response signal.

12. The apparatus according to claim 10, wherein the instructions causing the processor to send the parameter control instruction to the predetermined smart terminal include instructions causing the processor to:
obtain a predetermined operation corresponding to the surrounding smart terminal when the surrounding smart terminal is located in the predetermined safe region; and
send the parameter control instruction to the predetermined smart terminal corresponding to the predetermined operation.

13. The apparatus according to claim 10, wherein the instructions causing the processor to identify the surrounding smart terminal currently near the local terminal include instructions causing the processor to:
identify the surrounding smart terminal currently near the local terminal according to a fixed position of the surrounding smart terminal in the space.

14. The apparatus according to claim 13, wherein the instructions causing the processor to identify the surrounding smart terminal currently near the local terminal include instructions causing the processor further to:
detect a relative position of the local terminal in the space, including:
sending a locating signal to a routing device providing network resources for the local terminal and all smart terminals; and
receiving the relative position of the local terminal in the space returned from the routing device,
wherein the relative position includes at least one of a first relative position with respect to the routing device or a second relative position with respect to the surrounding smart terminal.

15. The apparatus according to claim 14, wherein the instructions causing the processor to identify the surrounding smart terminal currently near the local terminal according to the fixed position of the surrounding smart terminal in the space include instructions causing the processor to:
identify the surrounding smart terminal currently near the local terminal according to the fixed position of the surrounding smart terminal and a fixed position of the routing device in the space, if the relative position of the local terminal includes the first relative position; or
identify the surrounding smart terminal currently near the local terminal according to a distance between the surrounding smart terminal and the local terminal, if the relative position of the local terminal includes the second relative position.

16. The apparatus according to claim 14, wherein the instructions causing the processor to identify the surrounding smart terminal currently near the local terminal according to the fixed position of the surrounding smart terminal in the space include instructions causing the processor to:
receive a confirmation response returned from the routing device after sending the locating signal to the routing device, the confirmation response including information regarding the surrounding smart terminal.

17. The apparatus according to claim 10, wherein:
the instructions causing the processor to send the parameter control instruction to the surrounding smart terminal include instructions causing the processor to send the parameter control instruction to the surrounding smart terminal according to at least one of a current time or environment information,
the instructions causing the processor to send the parameter control instruction to the predetermined smart terminal include instructions causing the processor to send the parameter control instruction to the predetermined smart terminal according to at least one of the current time or the environment information, and
the instructions causing the processor to change the parameter setting of the local terminal include instructions causing the processor to change the parameter setting of the local terminal according to at least one of the current time or the environment information.

18. The apparatus according to claim 10, wherein the instructions further cause the processor to:
record a control action, the recorded control action including at least one of sending the parameter control instruction to the surrounding smart terminal, sending the parameter control instruction to the predetermined smart terminal, or changing the parameter setting of the local terminal according to the predetermined parameter setting; and
performing at least one of the following according to the recorded control action:
sending the parameter control instruction to the surrounding smart terminal;
sending the parameter control instruction to the predetermined smart terminal; or
changing the parameter setting of the local terminal.

19. A non-transitory computer-readable storage medium having stored therein instructions that, when executed by a processor of a local terminal, cause the processor to:
identify a surrounding smart terminal currently near the local terminal; and
perform at least one of the following when the surrounding smart terminal is located in a predetermined safe region:
sending a parameter control instruction to the surrounding smart terminal;
sending the parameter control instruction to a predetermined smart terminal; or
changing a parameter setting of the local terminal according to a predetermined parameter setting.
